(19) United States
(12) Patent Application Publication
(10) Pub. No.: US 2014/0374168 A1
(43) Pub. Date: Dec. 25, 2014

(54) Drill Chuck Isolator

(71) Applicant: CORRY RUBBER CORPORATION, Corry, PA (US)

(72) Inventors: Robert Joseph Michael, Waterford, PA (US); Ernest B. Ferro, JR., Corry, PA (US); Jeffrey A. Ferro, Corry, PA (US); David Scott Yantex, Bethel Pak, PA (US); Lynn A. Alcorn, Greensburg, PA (US)

(21) Appl. No.: 14/370,203

(22) PCT Filed: Jan. 3, 2013
(86) PCT No.: PCT/US13/20121

§ 371 Date: Jul. 1, 2014

Related U.S. Application Data
(60) Provisional application No. 61/582,689, filed on Jan. 3, 2012.
(60) Provisional application No. 61/746,186, filed on Dec. 27, 2012.

(51) Int. Cl. E21B 17/07; E21B 7/02; B23B 31/00

(52) U.S. Cl. CPC E21B 17/07; B23B 31/00; E21B 7/025; B23B 2250/00; B23B 2250/16
USPC 175/320; 279/142

(57) ABSTRACT

A chuck isolator for the chuck of a drill comprising a base plate mountable to the chuck, a drive plate connectable to a drill bit, and a first elastomeric member interposed between the base plate and the drive plate. The base plate and the drive plate are wider than the drill bit. The chuck isolator is connectable to the chuck of the drill and capable of providing sound and vibration isolation when the chuck isolator is connected to the drill.

This application takes priority from U.S. Provisional Patent Applications Nos. 61/582,689 filed on Jan. 3, 2012, Ser. No. 61/746,178 filed on Dec. 27, 2012, Ser. No. 61/746,186 filed on Dec. 27, 2012 each of which are incorporated herein by reference.

### BACKGROUND

What is presented is a sound damping apparatus for drills and drill assemblies. Drills are machines that rotate a drill assembly to bore a hole into a substrate of some sort, usually a wall, or rock, or other material. Drill assemblies can be, for example, a roof bolt drill assembly as used in underground mining operations.

Drill assemblies are typically mounted to the chuck of a drill at one end. A drill bit is mounted on the opposing end of the drill assembly. The drill bit may be extended from the drilling machine, such as a roof bolting machine or the like, by interposing a drill rod or a series of drill rods which allows for drilling deeper holes into the target matter substrate—typically a wall or, in the case of mining operations, rock and/or minerals.

One problem associated with the drilling operations is that a large amount of noise is generated. Studies have shown that, on average, drilling noise with roof bolting machines are the most significant contributor to a drill operator's noise exposure. Thus, hearing loss remains one of the most common occupational illnesses for underground coal miners.

Another problem associated with the drilling operation is mechanical failure of one or more of the various components of the drill assembly that typically results from one or more factors, such as, for example, the size limitations of the drill rod components, the mechanical forces encountered in the drilling operation and the rigid connections between the various components of the drill assembly.

Thus, it would be desirable to have a drill and/or a drill assembly that overcomes these problems.

### SUMMARY

What is presented is a chuck isolator for the chuck of a drill. The chuck isolator comprises a base plate that is mountable to the chuck, a drive plate that is connectable to a drill bit, and a first elastomeric member that is interposed between the base plate and the drive plate. The base plate and the drive plate are each wider than the drill bit. The chuck isolator is connectable to the chuck of the drill and is capable of providing sound and vibration isolation when the chuck isolator is connected to the drill. Some embodiments of the chuck isolator could comprise a sidewall that encloses the first elastomeric member within the chuck isolator. Some embodiments of the chuck isolator could comprise a lip over the edge of the drive plate that limits the vertical and cocking movement of the drive plate.

The first elastomeric member can be connected to various components of the chuck isolator in a variety of ways. The first elastomeric member could be bonded to the drive plate or the base plate or both. In some embodiments, the chuck isolator could comprise a plurality of first elastomeric members each comprising an elastomeric core arranged between the base plate and the drive plate. The first elastomeric member could be made from any appropriate material including, but not limited to: polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

Some embodiments of the chuck isolator could comprise a top plate that is located above the drive plate. A second elastomeric member could be interposed between the top plate and the drive plate in some embodiments. The second elastomeric member could be bonded to the drive plate or the top plate or both.

Embodiments of the chuck isolator could incorporate features that limit the rotational movement of the first elastomeric member. For example, both the drive plate and the base plate could be cut and fit into corresponding opposing shapes. The chuck isolator could also comprise an opposing notch and groove that is incorporated into the drive plate and the base plate that limits the rotational movement of the first elastomeric member.

Some embodiments of the chuck isolator may also include an elastomeric outer ring. In some of these embodiments, the elastomeric outer ring is interposed between an intermediate plate and the drive plate and is bonded to both the drive plate and the intermediate plate. Moreover, in these embodiments the drive plate has a conical or spherical shape that is directed towards the chuck. In the embodiments where the chuck isolator has an elastomeric outer ring, the drive plate can also have a double conical or spherical shape that is directed towards both the chuck and the drill bit.

Any of the embodiments of chuck isolator presented herein could also be incorporated directly within the chuck of the drilling machine.

These and other aspects of the present invention will be more fully understood following a review of this specification and drawings.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 shows a drill assembly with a chuck isolator installed on the chuck of a drill;

FIG. 2 is an exploded view of the chuck isolator of FIG. 1;

FIG. 3A is a cross section of the perspective view of another embodiment of the chuck isolator;

FIG. 3B is an exploded view of the chuck isolator of FIG. 3A;

FIG. 4A is a cross section of the perspective view of another embodiment of the chuck isolator;

FIG. 4B is an exploded view of the chuck isolator of FIG. 4A;

FIG. 5A is a perspective view of another embodiment of the chuck isolator;

FIG. 5B is a cross section of the chuck isolator of FIG. 5A;

FIG. 5C is an exploded view of the chuck isolator of FIG. 5A;

FIG. 6A is a perspective view of another embodiment of the chuck isolator;

FIG. 6B is a cross section of the chuck isolator of FIG. 6A;

FIG. 6C is an exploded view of the chuck isolator of FIG. 6A;

FIG. 7A shows a perspective view of the torsional safety feature of an embodiment of the chuck isolator;

FIG. 7B shows a perspective view of the torsional safety feature of FIG. 7A fully engaged in one direction;

FIG. 8A is a another embodiment of the chuck isolator;

FIG. 8B is a cross section of the chuck isolator of FIG. 8A;

FIG. 8C is an exploded view of the chuck isolator of FIG. 8A;

FIG. 9A is a perspective view of another embodiment of the chuck isolator;

FIG. 9B is a different perspective view of the chuck isolator of FIG. 9A;

FIG. 9C is a cross section of the chuck isolator of FIG. 9A;

FIG. 9D is an exploded view of the chuck isolator of FIG. 9A;

FIG. 10A is a another embodiment of the chuck isolator;

FIG. 10B is a perspective view of the chuck isolator of FIG. 10A;

FIG. 10C is a cross section of the chuck isolator of FIG. 10A;

FIG. 10D is an exploded view of the chuck isolator of FIG. 10A;

FIG. 11 A is a another embodiment of the chuck isolator;

FIG. 11B is a cut out view of the chuck isolator of FIG. 11A showing the plurality of first elastomeric members;

FIG. 11C shows the base plate of the chuck isolator of FIG. 11A and the arrangement of its plurality of first elastomeric members;

FIG. 11D shows the base plate of a variation of the chuck isolator of FIG. 11A and an alternative arrangement of its plurality of first elastomeric members;

FIG. 11E shows the base plate of a variation of the chuck isolator of FIG. 11A and an alternative arrangement of its plurality of first elastomeric members;

FIG. 11F shows the base plate of a variation of the chuck isolator of FIG. 11A and an alternative arrangement of its plurality of first elastomeric members;

FIG. 11G shows the base plate of a variation of the chuck isolator of FIG. 11A and an alternative arrangement of its plurality of first elastomeric members;

FIG. 11H shows the base plate of a variation of the chuck isolator of FIG. 11A and an alternative arrangement of its plurality of first elastomeric members;

FIG. 12A is a another embodiment of the chuck isolator;

FIG. 12B is a cross section of the perspective view of the chuck isolator of FIG. 12A;

FIG. 13A is a perspective view of another embodiment of the chuck isolator;

FIG. 13B is a cross section of the perspective view of the chuck isolator of FIG. 13A;

FIG. 14A is a perspective view of another embodiment of the chuck isolator;

FIG. 14B is a cross section of the chuck isolator of FIG. 14A;

FIG. 15A shows the perspective view of the chuck of a drill; and

FIG. 15B is a cross section of the chuck of FIG. 15A showing a chuck isolator incorporated within the chuck.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

In rock drilling operations, a notable source of noise generation is the vibration of the drill rods and the chuck that is used to rotate the drill rod. There are three fundamental ways to reduce these vibrations, and the resulting noise: reduce the vibratory forces, attenuate the structural vibration using isolation or damping treatments, or attenuate the airborne noise with barriers or absorbers. The National Institute for Occupational Safety and Health (NIOSH) Office of Mine Safety and Health Research (OMSHR) has conducted various studies to quantify the vibration levels of the components associated with drilling roof bolt bore holes. The results show that a major source of noise is located just above the chuck and a second major source of the noise is centered on the drill rod below the interface of the drill rod and the media, which the drill is cutting into. These two areas were also shown to have high vibration levels. Therefore vibration isolation and damping are considered to be appropriate noise control methods. The focus of herein is on vibration isolation at or in the chuck.

Most of the noise emitted during drilling through rock media is due to noise radiated by the drill rods and chuck in response to forces at the drill bit-media interface. During drilling, the vibratory forces generated at the drill bit-media interface are transmitted to the drill rods and the chuck causing them to vibrate. Assuming linear viscous damping, the response of the structure is governed by:

[M]X″+[C]X′+[K]X=[F] (1)

where [M], [C], and [K] are the mass matrix, damping matrix, and stiffness of the structure; [F] is the vector of applied forces; and X″, X′, and X are the acceleration, velocity, and displacement response of the structure. Using the Laplace transform, substituting s=jω, and rearranging Equation (1) to solve for X yields:

[X]=[K+jωC−ω²M]⁻¹[F] (2)

where ω is the forcing frequency in units of rad/s and j denotes the √−1.

Assuming the damping is small enough to be ignored compared to the stiffness and the mass times the frequency squared, Equation (2) is reduced to:

[X]=[K−ω²M]⁻¹[F] (3)

For a fixed stiffness, Equation (3) shows that the response decreases with frequency squared once the frequency is well beyond the value where the ω²M term exceeds the stiffness, K. If the stiffness of the system is reduced, the frequency at which the ω²M term exceeds the stiffness decreases. Thus, isolation is achieved by decreasing the stiffness of the system. The stiffness of the system can be decreased by adding compliance via an isolation device. This would decrease the response of the system to high frequency input forces.

For a vibrating object, the sound power radiated is given by the following:

W=ρcS(v²)σ_{rad} (4)

where W is the sound power radiated, <v²> is the mean-squared vibration velocity, S is the vibrating area, ρ is the air density (km/m³), c is the speed of sound (m/s), and σ_{rad} is the radiation efficiency. Equation (4) shows that the sound power radiated by a vibrating structure be reduced if the surface-averaged mean-squared vibration velocity is directly displacement response of the system, so reducing the displacement response of the system will reduce the radiated noise. This vibration reduction can be accomplished with a properly designed vibration isolator.

As will be appreciated from the description and drawings set forth herein, such a vibration isolator provides for reduced noise during a drilling operation, as well as improved mechanical durability and flexibility of the drill assembly during the drilling operation. One of the limitations of designing isolators for a drill bit is that the isolator cannot be wider than the drill bit because an isolator located behind the drill bit should not impede the progress of the drill bit through the drilled medium otherwise it will limit the depth to which the drill can operate. However, an isolator located at or near the chuck can be spaced away from the drill bit and therefore does not have the same size restrictions. Therefore, chuck isolators can be much wider than the drill bit, as is the case for all of the embodiments disclosed herein.

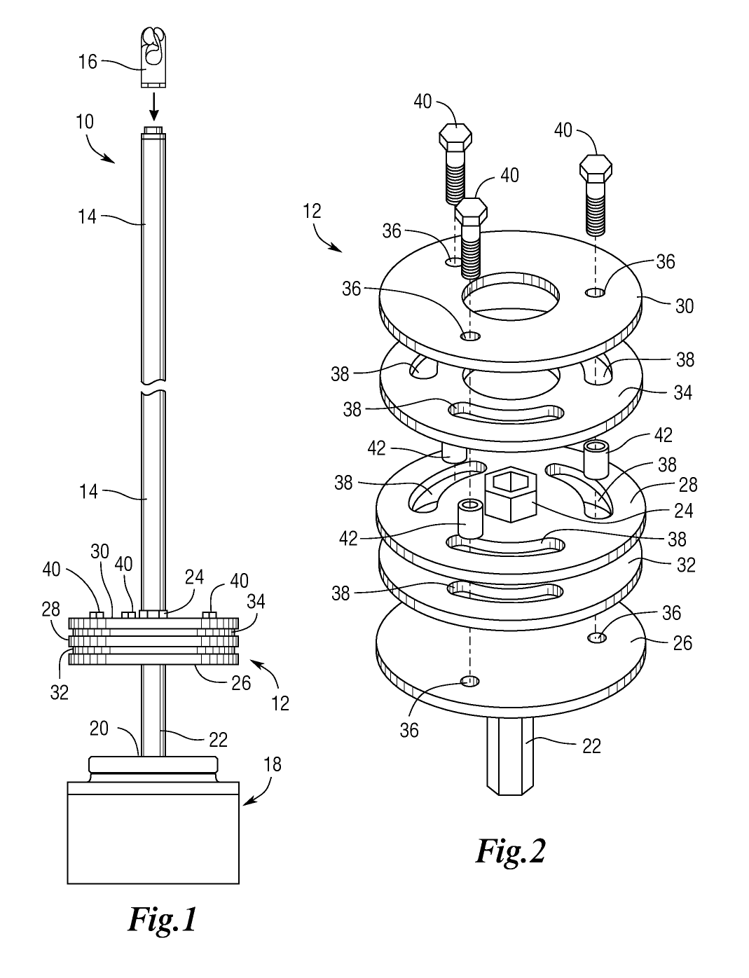

FIG. 1 illustrates a drill assembly 10 (e.g. a roof drill bit assembly) that incorporates an embodiments of a chuck isolator 12 that incorporates some of the vibration and sound isolation principles outlined above. It will be appreciated that the invention is not limited to a roof bolt drill assembly and that drill assemblies for other applications would equally benefit, but such an assembly is provided for purposes of illustration.

The drill assembly 10 includes one or more drill rods 14 that are removably connected between the chuck isolator 12 and a drill bit 16. The drill bit 16 is removably attached to drill rods 14. The drill assembly 10 also includes a means for driving the drill assembly 10 which may be, for example, a drilling machine or drill 18. The drill assembly 10 is mounted to a chuck 20 on the drill 18 by removably attaching the chuck isolator 12 to the chuck 20.

In some applications, the drill rods 14 may be eliminated if extension of the drill bit 16 is not required. In fact, in some applications, a single chuck isolator 12, by itself may provide sufficient extension of the drill bit 16 such that the drill assembly 10 would then comprise the drill bit 16 mounted to the chuck isolator 12 which is mounted to the chuck 20 of the assembly of the drill 18. In these instances, the chuck isolator 12 will act as both a chuck isolator and a bit isolator as defined herein.

As best understood by comparing FIGS. 1 and 2, the chuck isolator 12 has a chuck mounting end 22, by which the chuck isolator 12 is mounted to the chuck 20 of the drill 18. At the other end, a drill assembly mounting end 24 connects the chuck isolator 12 to the rest of the drill assembly 10. This embodiment of chuck isolator 12 comprises a series of sound and vibration isolation elastomeric members interposed between steel plates to perform the bulk of the isolation that the chuck isolator 12 provides. In this embodiment, the chuck mounting end 22 is mounted to a base plate 26 and the drill assembly mounting end 24 is mounted to a drive plate 28. The chuck isolator is capped with a top plate 30 above the drive plate 28, i.e. located over the drill bit 16 facing side of the drive plate 28. A first elastomeric member 32 is interposed between the drive plate 28 and the base plate 26 and a second elastomeric member 34 is interposed between the drive plate 28 and the top plate 30. The top plate 30 and the base plate 26 have a series of threaded openings 36 and the intervening first elastomeric member 32, second elastomeric member 34, and drive plate 28 have corresponding slots 38 through which securing bolts 40 are passed through to create a complete chuck isolator 12. Spacer bushings 42 may be positioned axially with the bolts 40 if desired to maintain spacing within the chuck isolator 12.

The bolts 40 provide the only connection between the chuck 20 of the drill 18 and the rest of the drill assembly 10.

The chuck isolator 12 reduces the amount of vibration and noise generated during a drilling operation. The chuck isolator 12 also reduces the potential for mechanical failure of the drill assembly 10 during operation. Specifically, the first elastomeric member 32 and the second elastomeric member 34 in the chuck isolator 12 increase the flexibility of the drill assembly 10. The first elastomeric member 32 and the second elastomeric member 34 allow for the stiffness or rigidity of the chuck isolator 12 to be controlled or adjusted as desired to reduce or minimize mechanical failure of the various components that make up the drill assembly 10. For example, drill assemblies 10 without such chuck isolators 12 have a stiff or rigid mechanical connection between the chuck 20 of the drill 18 and the drill rods 14. During operation, these components experience large mechanical stresses and/or forces due to the nature of the drilling process. Thus, it will be appreciated that the chuck isolator 12 advantageously reduces the mechanical stresses and/or forces that the drill assembly 10 components are subjected to, since both the first elastomeric member 32 and second elastomeric member 34 provide for improved overall flexibility between the various components of the drill assembly 10.

Both the first elastomeric member 32 and the second elastomeric member 34 provide compliance in multiple directions and provide sound and vibration isolation. The actual number, type, and other properties of the elastomeric members can be varied depending on the specific application. Additional intermediary plates could be interposed between these additional elastomeric members if desired for additional strength. Both the first elastomeric member 32 and second elastomeric member 34 can be made from any appropriate material including, but not limited to, polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or other heavily damped elastomer such as those manufactured by Cony Rubber Corporation of Corry, Pa. Optimal elastomers are selected based on critical material properties such as loss factor (damping) and dynamic modulus for maximizing noise and vibration isolation. It should be understood that the isolators could also be made from a series of coil springs or leaf springs or the isolators could be made from wire rope, as an alternative to elastomer.

The top plate 30, drive plate 28, and base plate 26 are preferably manufactured out of 4130/4140 steel and heat treated to 35 HRC. However, it will be understood that other materials may be utilized if the particular applications require it.

The embodiment shown in FIGS. 1 and 2 are highly tunable. In other words, the first elastomeric member 32 and the second elastomeric member 34 can be swapped out for variations that alter stiffness (durometer) and damping or with other materials altogether. In addition, the pre-compression of the first elastomeric member 32 and the second elastomeric member 34 can be altered adding spacers of different lengths 52. This allows the chuck isolator to be highly tunable since pre-compression can have a great impact on the stiffness of the elastomeric members. In addition, the configurations of the first elastomeric member 32 and the second elastomeric member 34 can all be adjusted for optimal noise isolation. Furthermore, the first elastomeric member and second elastomeric member have been shown to be single continuous pieces, but it can be shown that each of the first elastomeric member and second elastomeric member can be made up of multiple elastomeric rings compressed together within the isolator. Also, as the embodiment is modular and not permanently bonded together, worn components can easily be replaced.

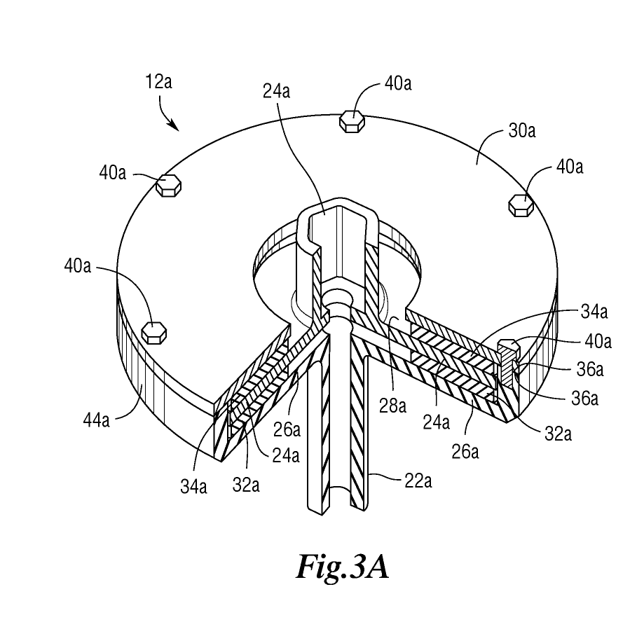

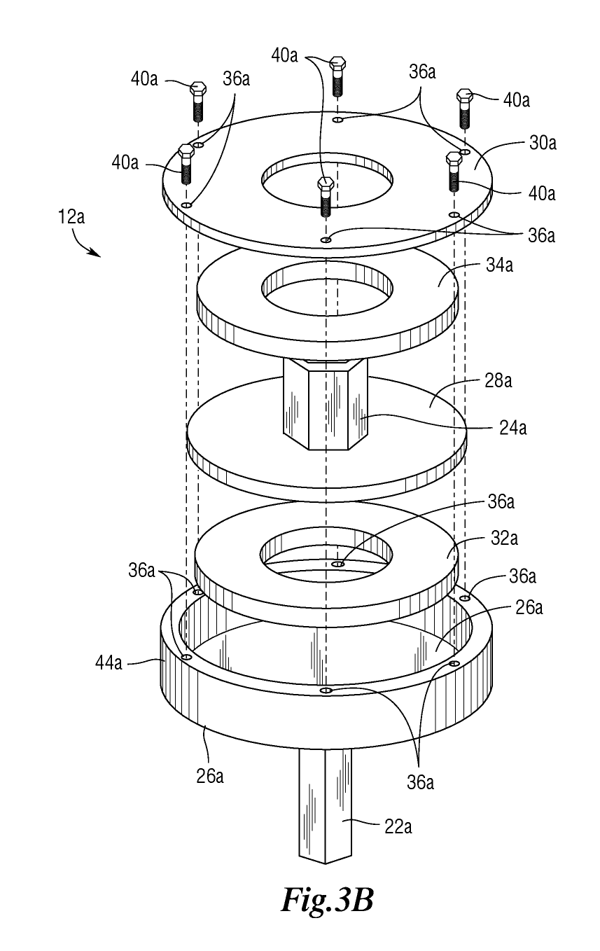

FIG. 3A depicts an embodiment of chuck isolator 12a in which the first elastomeric member 32a and the second elastomeric member 34a are better protected from the drilling environment. As best understood by comparing FIGS. 3A and 3B, in this embodiment the base plate 26a has a raised sidewall 44a that forms a container into which drive plate 28a and the first elastomeric member 32a and the second elastomeric member 34a are located. The top plate 30a serves to cap the assembly. Threaded bolts 40a are passed through a series of threaded openings 36a in the top plate 30a and the base plate 26a to create a complete chuck isolator 12a. In this embodiment, the only connection between the chuck mounting end 22a and the drill assembly mounting end 24a is the compression of the first elastomeric member 32a and the second elastomeric member 34a against the drive plate 28a. This compression is sufficient to drive the drill assembly while still allowing for the first elastomeric member 32a and the second elastomeric member 34a to provide both sound and vibration isolation. If required, spacers (not shown in this embodiment) could be used between the side wall 44a and the top plate 30a to adjust the compression of the first elastomeric member 32a and the second elastomeric member 34a. As with the earlier embodiment, this chuck isolator 12a is highly tunable. In other words, the first elastomeric member 32a and/or the second elastomeric member 34a can be swapped out for variations that alter stiffness (durometer) or with other materials altogether. In addition, the pre-compression of the first elastomeric member 32a and the second elastomeric member 34a can be altered by tightening or loosening the bolts 40a. In addition, as previously discussed, the configuration of the first elastomeric member 32a and the second elastomeric member 34a can all be adjusted for optimal noise isolation. Also, as the embodiment is modular and not permanently bonded together, worn components can easily be replaced. Variations of this embodiment could have additional elastomeric members with intervening intermediate plates.

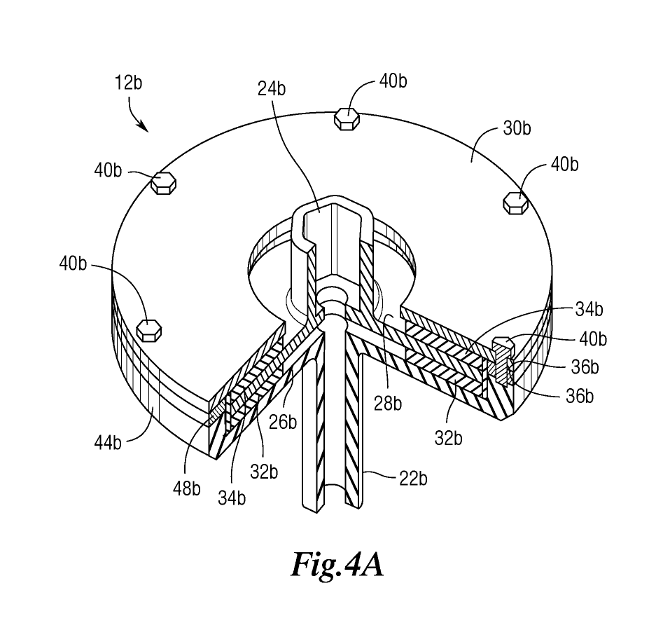

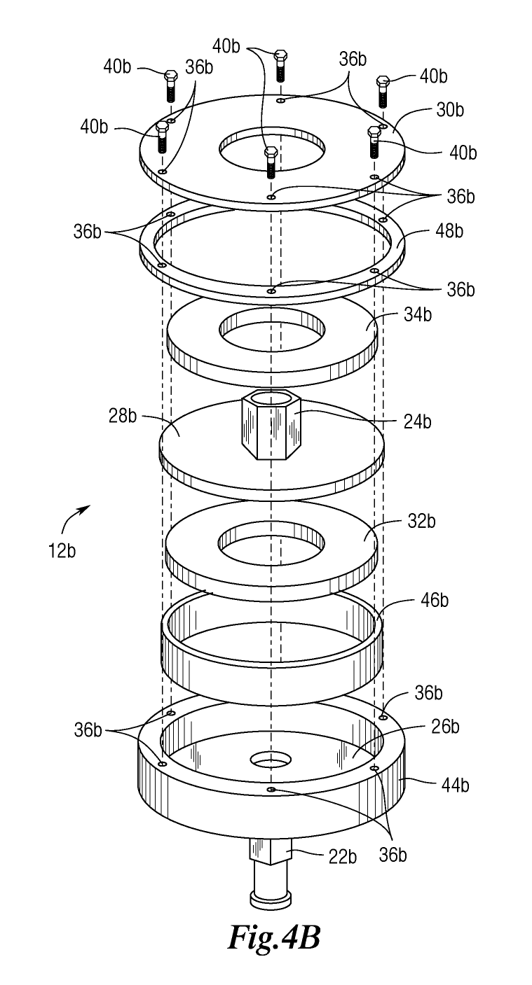

FIGS. 4A and 4B depict another embodiment of the chuck isolator 12b in which the base plate 26b has a raised sidewall 44b. The enclosed nature of the chuck isolator 12b allows for features to be added while providing additional functionality. As best understood by comparing FIGS. 4A and 4B, in this embodiment the base plate 26b has a raised sidewall 44b that forms a container into which the drive plate 28b, first elastomeric member 32b, and second elastomeric member 34b are each located. An elastomeric outer ring 46b is inserted between the inside of the sidewall 44b and the outside of the drive plate 28b and the first elastomeric member 32b and the second elastomeric member 34b. The top plate 30b serves to cap the assembly. A spacer ring 48b between the side wall 44b and the top plate 30b adjusts the pre-compression of the first elastomeric member 32b and the second elastomeric member 34b. Threaded bolts 40b are passed through a series of threaded openings 36b in the top plate 30b, the spacer ring 48b and the base plate 26b to create a complete chuck isolator 12b. In this embodiment, the only connection between the chuck mounting end 22b and the drill assembly mounting end 24b is the compression of the first elastomeric member 32a and the second elastomeric member 34b against the drive plate 28b. This compression is sufficient to drive the drill assembly while still allowing for the first elastomeric member 32b and the second elastomeric member 34b to provide both sound and vibration isolation. As noted in the figures, the first elastomeric member 32a and the second elastomeric member 34b are of differing sizes, with the first elastomeric member 32b being thicker than the second elastomeric member 34b. As with the earlier embodiment, this chuck isolator 12b is highly tunable. In other words, the first elastomeric member 32b and the second elastomeric member 34b can be swapped out for variations that alter stiffness (durometer), damping, or with other materials altogether. In addition, the pre-compression of the first elastomeric member 32b and the second elastomeric member 34b can be altered by tightening or loosening the bolts 40b. In addition, as previously discussed, the configuration of the first elastomeric member 32b and the second elastomeric member 34b can all be adjusted for optimal noise isolation. Also, as this particular embodiment is modular and not permanently bonded together, worn components can be easily replaced. Variations of this embodiment could also have additional elastomeric members with intervening intermediate plates.

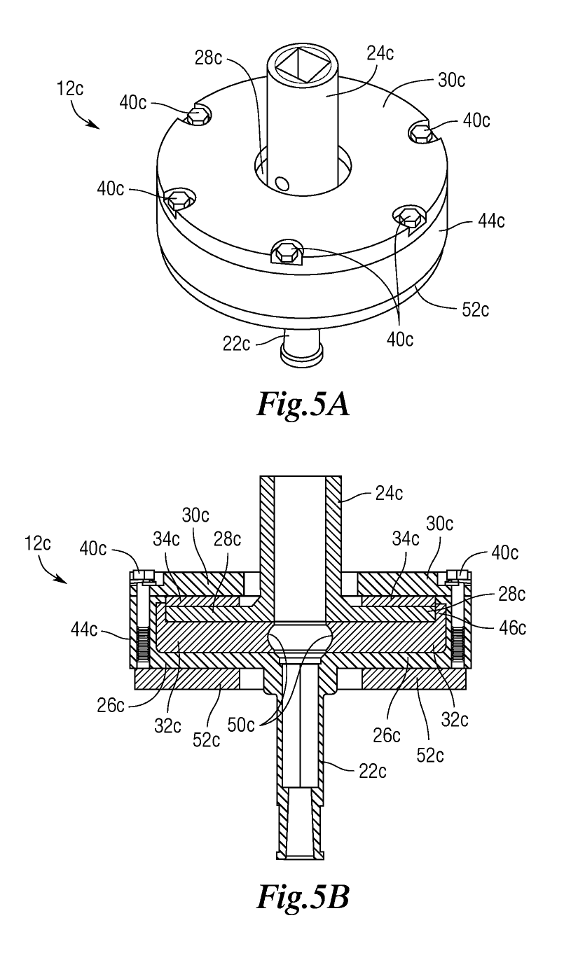

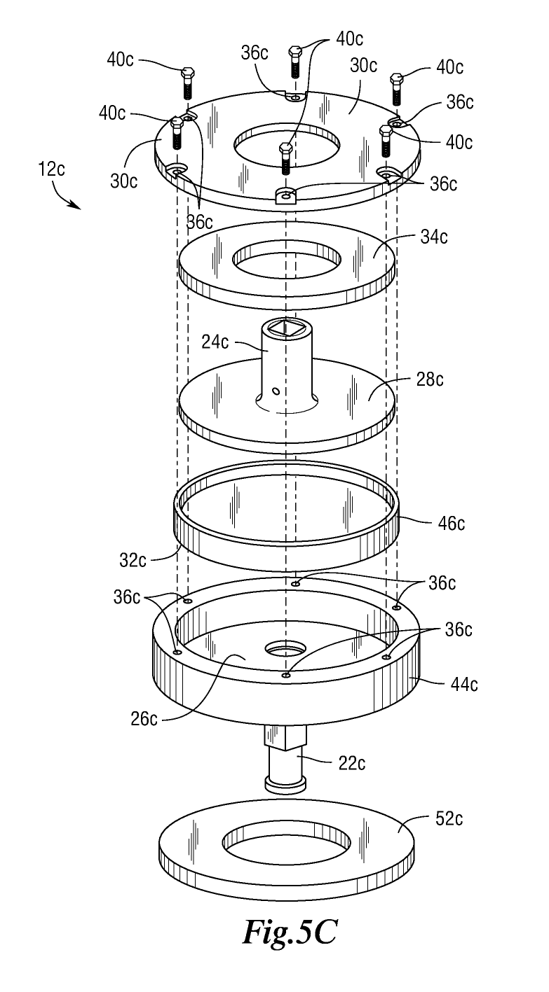

FIGS. 5A through 5C depicts an embodiment of chuck isolator 12c that incorporates further refinements. As best understood by comparing FIGS. 5A-5C, in this particular embodiment, as with earlier embodiments, the base plate 26c has a raised sidewall 44c that forms a container into which the drive plate 28c, first elastomeric member 32c, and second elastomeric member 34c are each located. In this embodiment, the first elastomeric member 32c forms an elastomeric outer ring 46c into which the drive plate 28c sits. One other feature best seen in FIG. 5B, is that the inner diameter 50c of the first elastomeric member 32c is contoured to eliminate air flow choking, which is possible through the gap between the elastomeric member and the drill rods under the earlier described embodiments.

As with earlier embodiments, the top plate 30c serves to cap the chuck isolator 12c assembly. Threaded bolts 40c are passed through a series of threaded openings 36c in the top plate 30c and the base plate 26c to create a complete chuck isolator 12c. However, in this embodiment, the threaded openings 36c in top plate 30c are recessed so that the top of the bolts 40c are flush with the top of the top plate 30c in the completed chuck isolator 12c. This particular embodiment lacks a spacer, but one could be added if called for by a particular application.

A third elastomeric member 52c is mounted to the underside of the base plate 26c to provide additional isolation. As with the embodiments previously described, in this embodiment, the only connection between the chuck mounting end 22c and the drill assembly mounting end 24c is the compression of the first elastomeric member 32c and the second elastomeric member 34c against the drive plate 28c. This compression is sufficient to drive the drill assembly while still allowing both the first elastomeric member 32c and the second elastomeric member 34c to provide sound and vibration isolation. As noted in the figures, the first elastomeric member 32c and the second elastomeric member 34c are of differing sizes, with the first elastomeric member 32c being thicker than the second elastomeric member 34c. As with the earlier embodiment, this chuck isolator 12c is highly tunable. In other words, the first elastomeric member 32c and the second elastomeric member 34c can be swapped out for variations that alter stiffness (durometer), damping, or with other materials altogether. In addition, the pre-compression of the first elastomeric member 32c and the second elastomeric member 34c can be altered by tightening or loosening the bolts 40c. In addition, as previously discussed, the configuration of the first elastomeric member 32c and the second elastomeric member 34c can all be adjusted for optimal noise isolation. Also, as this embodiment is modular and not permanently bonded together, worn components can easily be replaced. Variations of this embodiment could have additional elastomeric members with intervening intermediate plates.

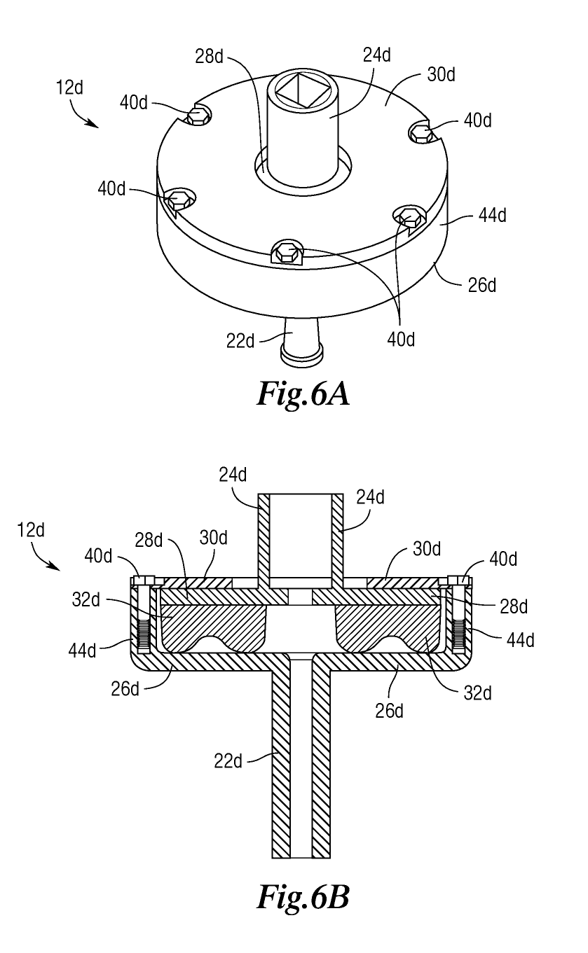

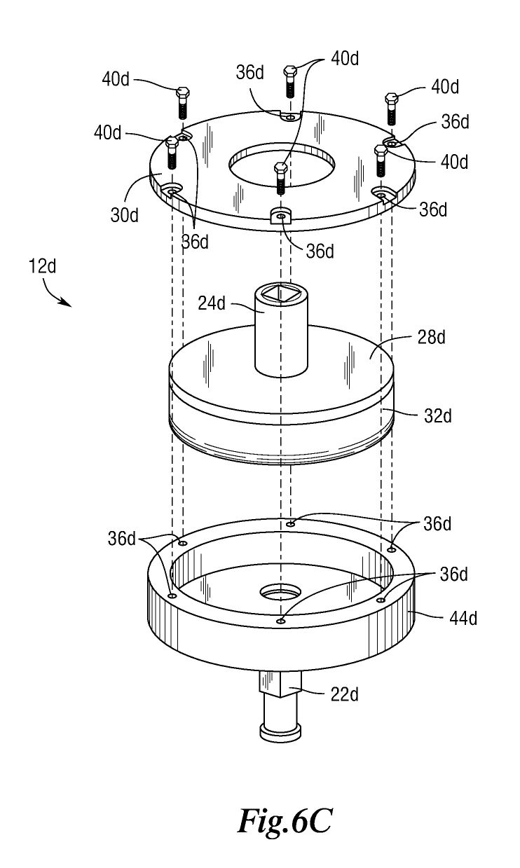

The embodiment shown in FIGS. 6A-6C depicts a variation in the implementation of the elastomeric members 32d that could be applied to any embodiment discussed herein. The embodiment shown in these figures has only a first elastomeric member 32d which is chemically bonded to the bottom of the drive plate 28d. Bonding the elastomeric members 32d improves their durability and provides a consistent stiffness. The first elastomeric member 32d could be bonded to the top of the base plate 26d instead, to obtain the same effect. In another variation (not shown), the first elastomeric member 32d could be interposed between the drive plate 28d and the top plate 30d and bonded to either the drive plate 28d or the top plate 30d, to achieve the same benefits of increased durability and consistent stiffness.

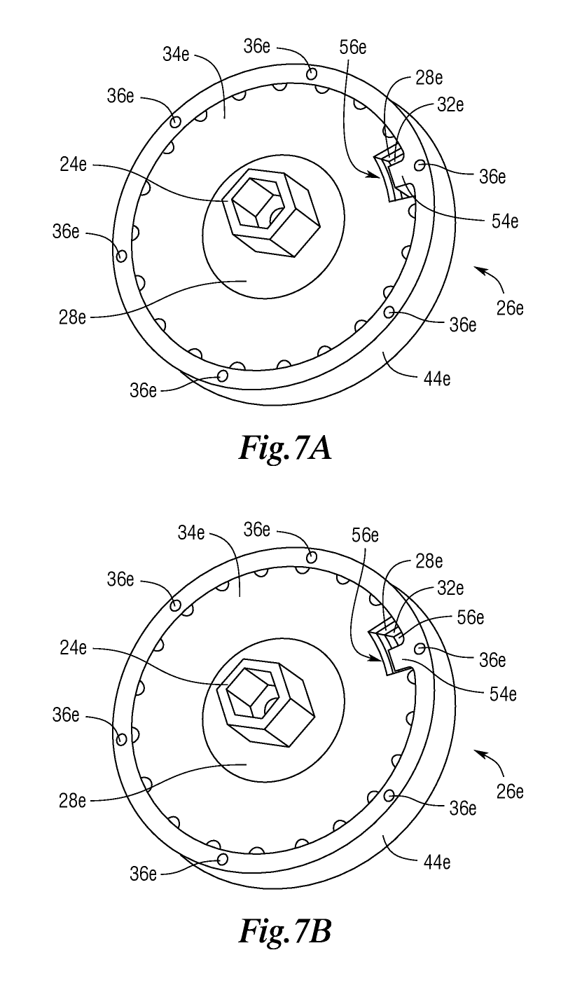

FIG. 7A depicts another feature that could be implemented in any variation described herein. FIG. 7A is a perspective view of the top of a base plate 26e and a drive plate 28e having a torsional safety feature. In this embodiment, a flange 54e is formed into the base plate 26e that sits in a notch 56e that is formed in the drive plate 28e. The first elastomeric member 32e and the second elastomeric member 34e are also cut to fit in the notch 56e. As can be seen in FIG. 7B, when the chuck isolator 12e is in operation the rotation of the drilling assembly in either direction will impart a torsional force on the base plate 26e. The compression of the first elastomeric member 32e and the second elastomeric member 34e between the base plate 26e and the drive plate 28e are sufficient for the remainder of the drill assembly to operate, however any excess torque imparted to the system would be experienced as a rotational movement of the first elastomeric member 32e and the second elastomeric member 34e within the base plate 26e. When enough a movement occurs, the flange 54e presses up against the side of the notch 56e which limits the extent of this rotational deflection within the base plate 26e. The notch 56e is sized to limit the deflection to an acceptable amount. It will be understood that the location of the notch 56e and the flange 54e could be switched in other embodiments with the notch 56e being cut into the base plate 26e and the flange 54e being formed into the drive plate 28e. In addition, some embodiments could have a layer of elastomeric material along the surface of the notch 56e or coating the flange 54e, or both.

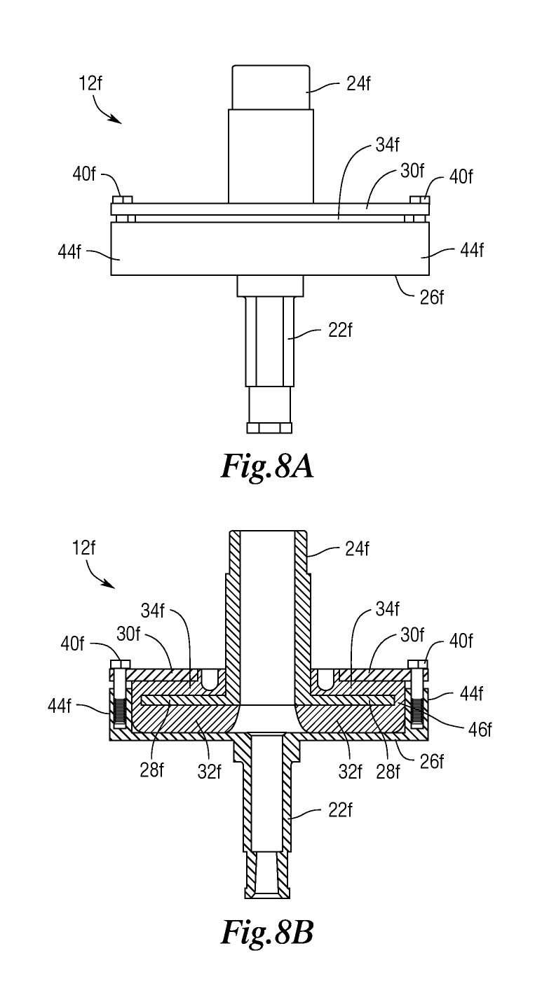

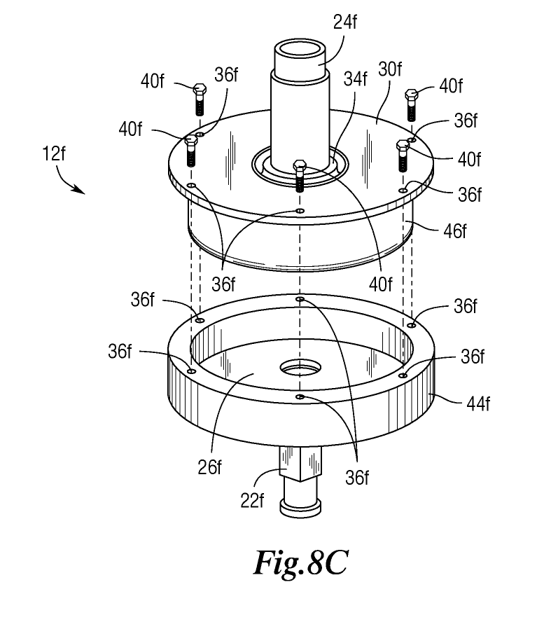

FIGS. 8A through 8C show an embodiment of chuck isolator 12f in which both the first elastomeric member 32f and the second elastomeric member 34f are bonded to the drive plate 28f and the top plate 30f. In this embodiment, the first elastomeric member 32f and the second elastomeric member 34f are molded to encapsulate the drive plate 28f and to also create an elastomeric outer ring 46f with the top of the second elastomeric member 34f bonded to the bottom of the top plate 30f. This assembly fits into the base plate 26f with the elastomeric outer ring 46f pushing against the sidewall 44f. Threaded bolts 40f are passed through a series of threaded openings 36f in the top plate 30f and the base plate 26f to create a complete the chuck isolator 12f. The first elastomeric member 32f and the second elastomeric member 34f are compressed within the chuck isolator 12f even before the chuck isolator 12f experiences any external forces from the operation of the drill.

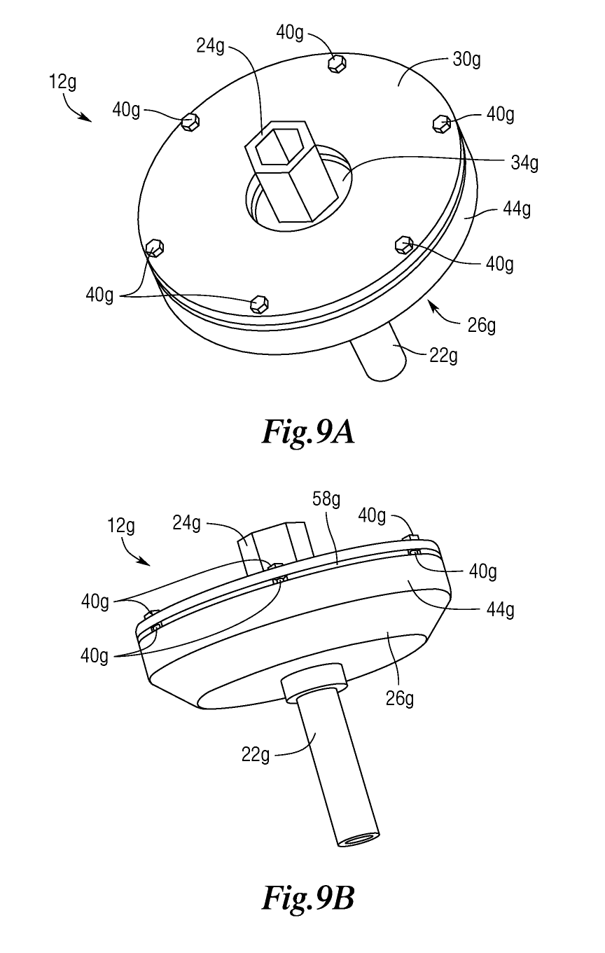

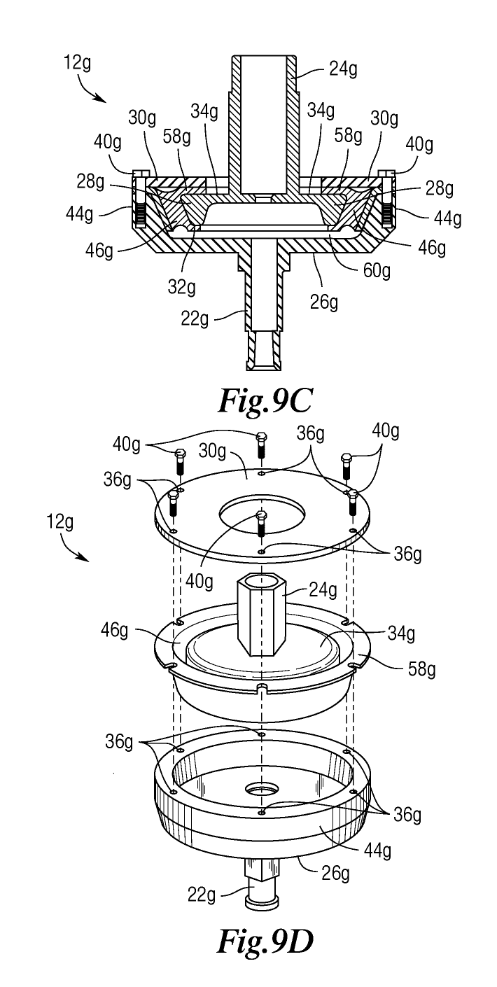

Various other embodiments of chuck isolators have been developed to reduce the cocking stiffness of the drill assemblies in addition to providing both sound and vibration isolation. Such a reduction in cocking stiffness extends the drill rod life and improves safety by preventing drill rods from breaking. This is achieved since the chuck isolator 12g, which acts as a spring in series with the drill rod 14g, is much less stiff than the drill rod 14g and therefore will deflect if the drill rod 14g experiences bending forces or offset deformation. The chuck isolator 12g depicted in FIGS. 9A through 9D show one such embodiment. Here the drive plate 28g has a conical shape directed towards the chuck as best seen n FIGS. 9C and 9D. The first elastomeric member 32g is only a thin layer on the lower portion of the drive plate 28g. The second elastomeric member 34g is bonded to both the top of the drive plate 28g. An elastomeric outer ring 46g is connects both the first elastomeric member 32g and the second elastomeric member 34g and is also bonded to the drive plate 28g and an intermediate plate 58g. The base plate 26g has a sidewall 44g that is also shaped to accommodate the intermediate plate 58g and to also provide a clearance 60g between the first elastomeric member 32g and the base plate 26g. Threaded bolts 40g are passed through a series of threaded openings 36g in the top plate 30g, the intermediate plate 58g, and the base plate 26g to create a complete chuck isolator 12g. The second elastomeric member 34g is compressed within the chuck isolator 12g even before the chuck isolator 12g experiences any external forces from the operation of the drill. Both the elastomeric outer ring 46g and the clearance 60g give the drive plate 28g the ability to bend within the chuck isolator 12g in response to cocking and axial forces experienced during drilling operations. The angle of the drive plate 28g and the sidewall 44g can be adjusted to meet various axial and torsion stiffness requirements.

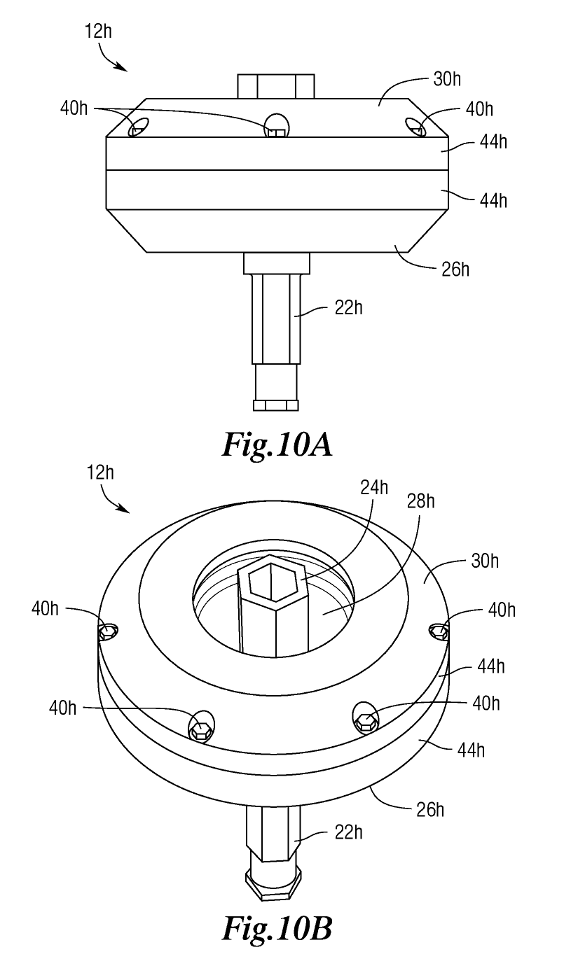

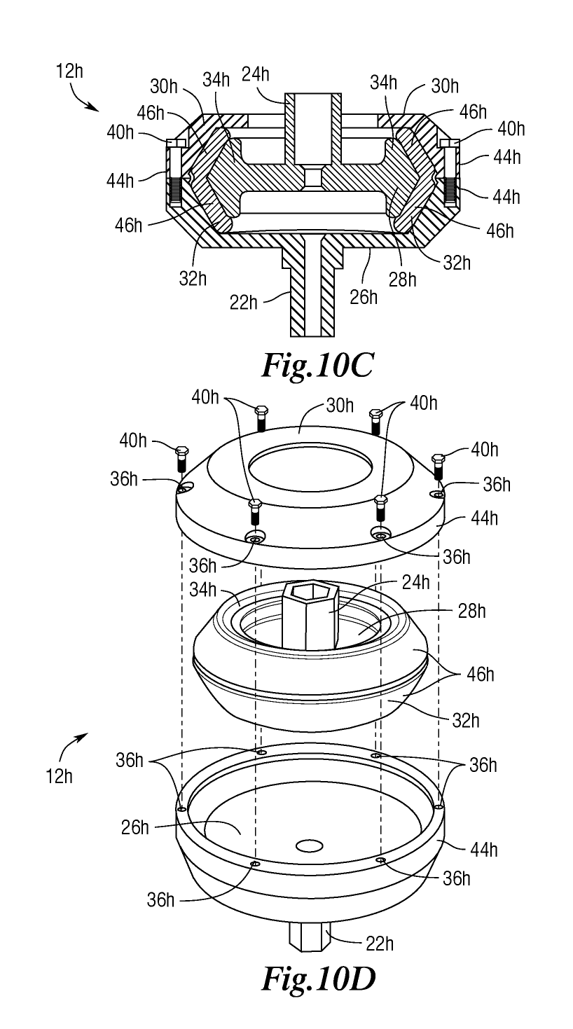

FIGS. 10A through 10D depict an embodiment of chuck isolator 12h in which the drive plate 28h has a double conical shape directed towards both the chuck and the drill bit that makes the chuck isolator 12h operate as a spherical joint, in addition to reducing overall axial and torsional stiffness. This embodiment also imparts a more uniform pre-compression on the elastomeric components within the chuck isolator 12h. The top plate 30h is contoured to mirror the base plate 26h to accommodate the shape of the drive plate 28h. The first elastomeric member 32h and the second elastomeric member 34h are much smaller in this embodiment than in earlier embodiments, but are still interposed between the base plate 26h and the drive plate 28h and between the drive plate 28h and the top plate 30h respectively. The bulk of the elastomeric component in this embodiment of the chuck isolator 12h is in the elastomeric outer ring 46h, which is compressed between the drive plate 28h and both the top plate 30h and the base plate 26h. In this embodiment, the various angles of the drive plate 28h, base plate 26h, and top plate 30h can be adjusted to meet various axial and torsion stiffness requirements.

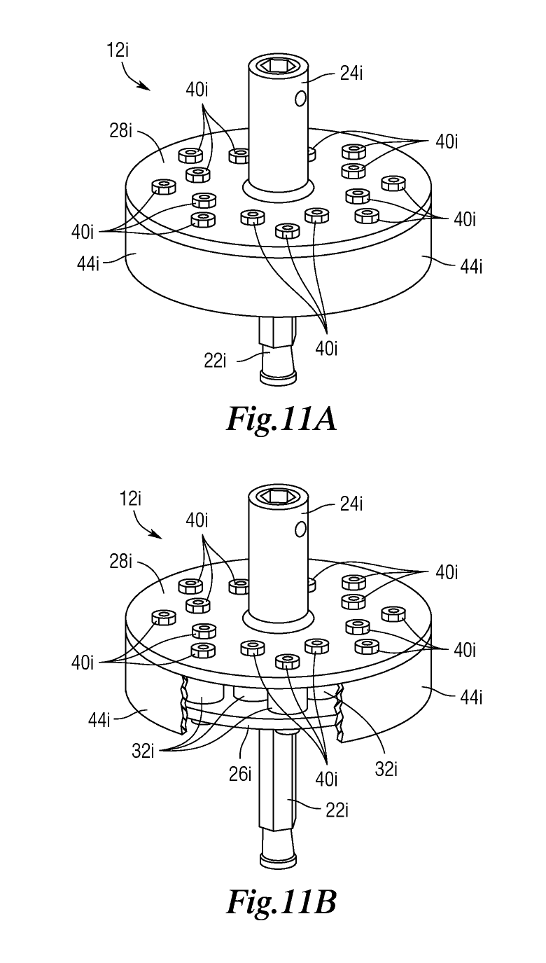

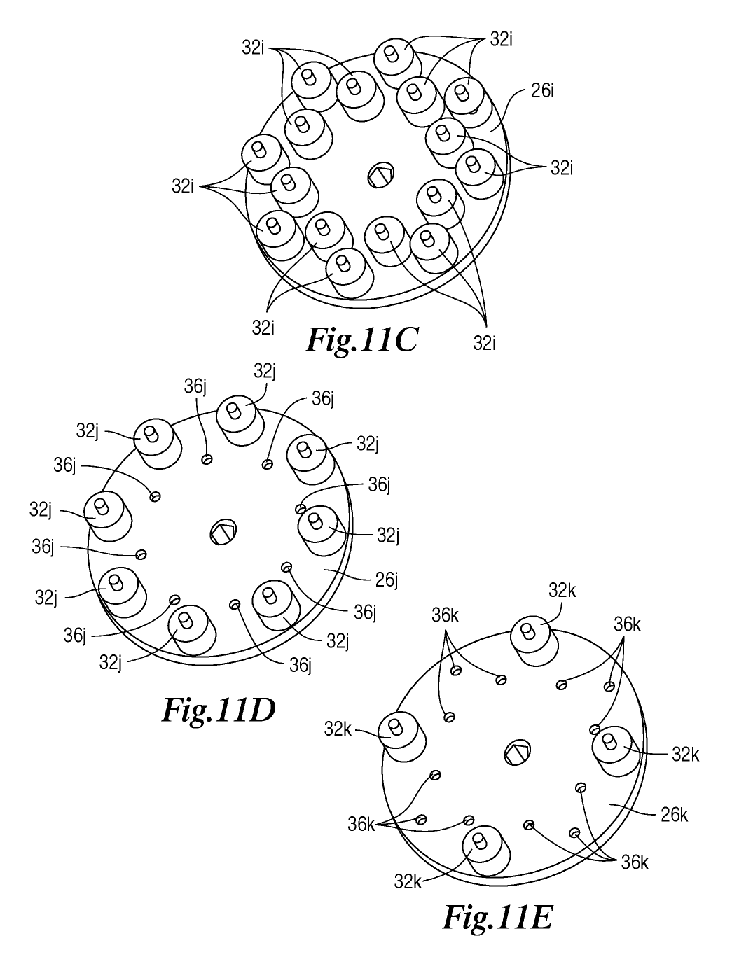

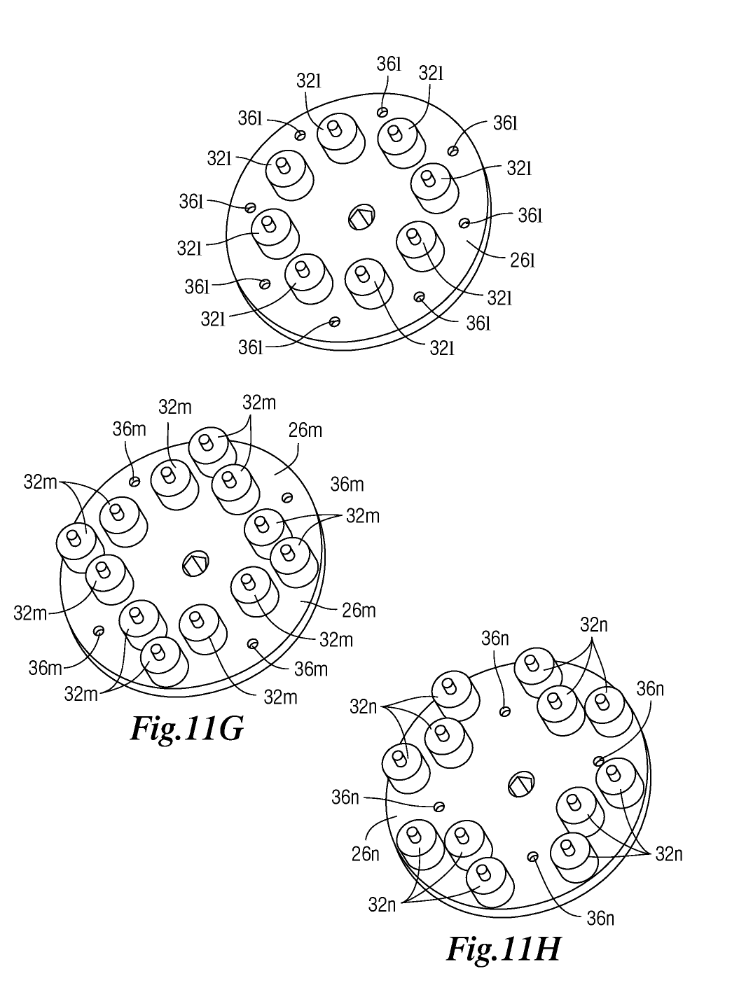

Another embodiment of chuck isolator 12i that comprises modular elastomeric components is shown in FIGS. 11A through 11C. This embodiment of chuck isolator 12i comprises a plurality of first elastomeric members 32i interposed between the drive plate 28i and the base plate 26i. Each first elastomer member 32i comprises an elastomer core that is threaded on both ends. The drive plate 28i and the base plate 26i each have a series of openings 36i through which the threaded ends of each first elastomeric member 32i fit through. Each first elastomeric member 32i is secured to both the drive plate 28i and the base plate 26i with securing bolts 40i, to create a complete chuck isolator 12i. A sidewall 44i incorporated into a cover serves to protect the plurality of first elastomeric members 32i between the drive plate 28i and the base plate 26i.

FIG. 11C shows the base plate 26i of the chuck isolator 12i has space for up to sixteen first elastomeric members 32i. In addition, the type, stiffness, and other properties of the first elastomeric members 32i can be selected, if necessary. The configuration of openings 36i shown in these figures are also not fixed and embodiments with different numbers and arrangements of openings 36i are also possible. FIGS. 11D through H show that the actual number, configuration, and arrangement of first elastomeric members can be varied according to the particular application. FIG. 11D shows an embodiment of the chuck isolator 12j that comprises eight first elastomeric members 32j arranged on the perimeter of the base plate 26j. FIG. 11E shows an embodiment of the chuck isolator 12k that comprises four first elastomeric members 32k arranged in a square shape on the base plate 26k. FIG. 11F shows another embodiment of the chuck isolator 121 that comprises eight first elastomeric members 321 arranged on the base plate 261. FIG. 11 G shows an embodiment of the chuck isolator 12m that comprises twelve first elastomeric members 32m arranged in a square shape on the base plate 26m. FIG. 11H shows another embodiment of the chuck isolator 12n that comprises twelve first elastomeric members 32n arranged in a square shape on the base plate 26n.

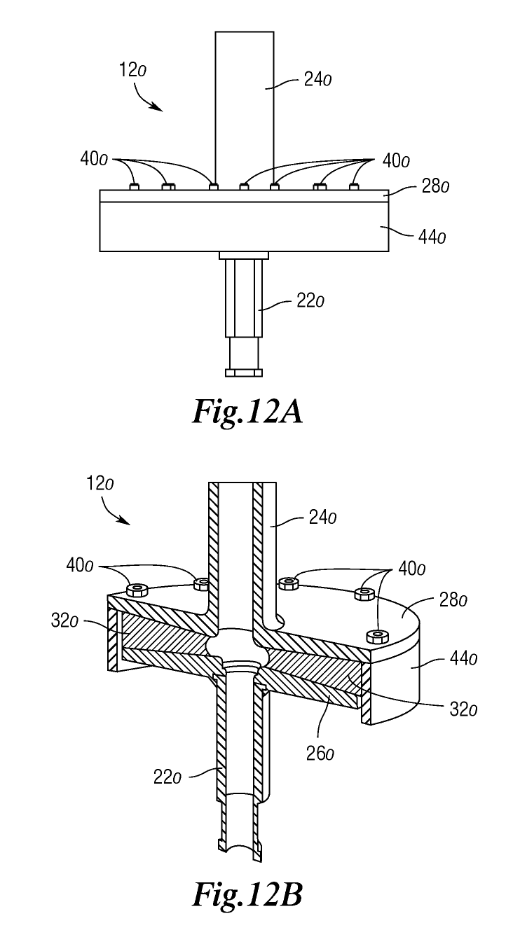

A less modular, simpler, embodiment of the chuck isolator 12o comprising a single first elastomeric member 32o is shown in FIGS. 12A and 12B. This embodiment of the chuck isolator 12o comprises a single first elastomeric member 32o bonded between both the drive plate 28o and the base plate 26o. A sidewall 44o, incorporated into a cover, serves to protect the first elastomeric members 32o. While this embodiment is not modular and the entire chuck isolator 12o would have to be replaced in case of the failure of any one part, it would be cheaper to produce than some of the other embodiments presented herein.

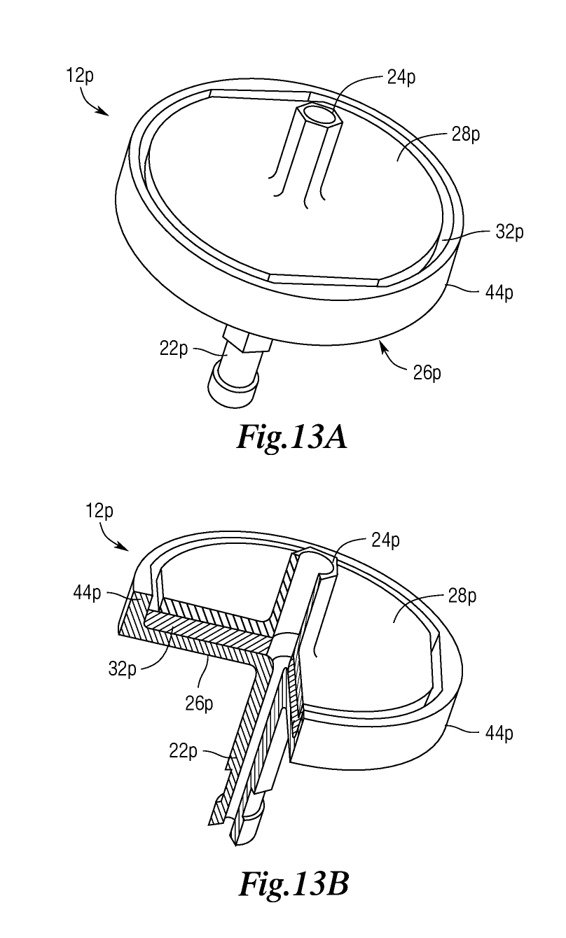

FIGS. 13A and 13B show an embodiment of the chuck isolator 12p that includes a torsional safety feature. In this embodiment, the drive plate 28p and the base plate 26p are bonded together between a single first elastomeric member 32p. The base plate 26p includes a sidewall 44p which has an inner circumference that is in the form of a flattened circle. The drive plate 28p fits into this space with a corresponding opposing shape. The gap between the drive plate 28p and the base plate 26p. As can be seen in FIG. 13B, when the chuck isolator 12p is in operation, the rotation of the drilling assembly in either direction will impart a torsional force on the base plate 26p. Excess torque imparted to the system is experienced as a rotational movement of the first elastomeric member 32p and the base plate 26p. When enough movement occurs, the base plate 26p presses up against the side of the drive plate 28p, which limits the extent of this rotational deflection within the base plate 26p. It will be understood that the shape of the sidewall 44p, the drive plate 28p, and base plate 26p could be varied so long as the corresponding opposing shapes of the drive plate 28p and the base plate 26p operate in the same manner.

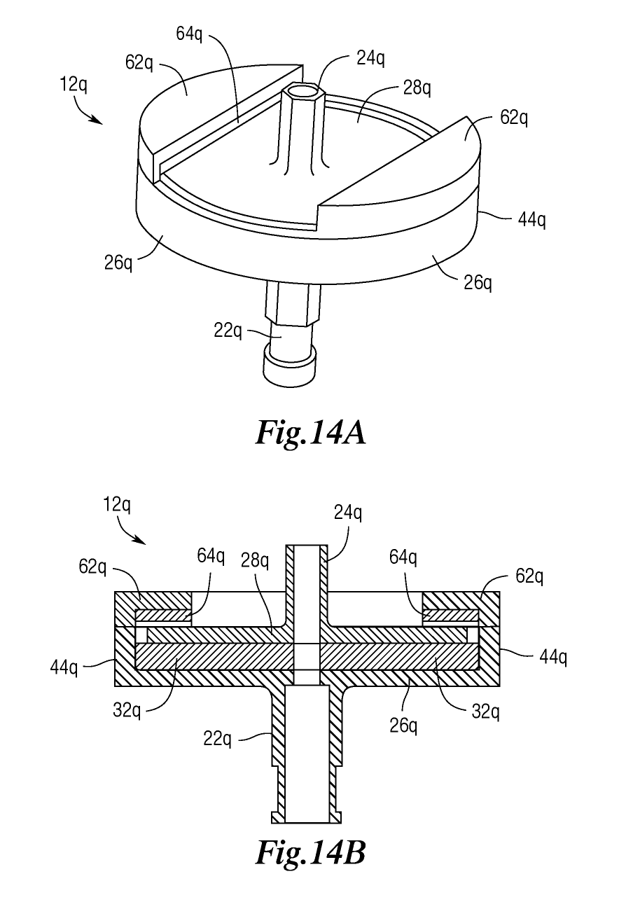

The embodiment shown in FIGS. 14A and 14B show an embodiment that includes a safety feature that will protect the drive plate 28q in the cocking and vertical direction to prevent potential failure during overload. In this embodiment, the drive plate 28q and the base plate 26q are bonded together between a single first elastomeric member 32q. The base plate 26q includes a sidewall 44q that incorporates a lip 62q that goes over the edge of the drive plate 28q. The clearance between the bottom of the lip 62q could be adjusted if pre-compression of the first elastomeric member 32q is required. In addition, a layer of elastomeric material 64q could be added to the bottom of the lip and above the drive plate 28q if required.

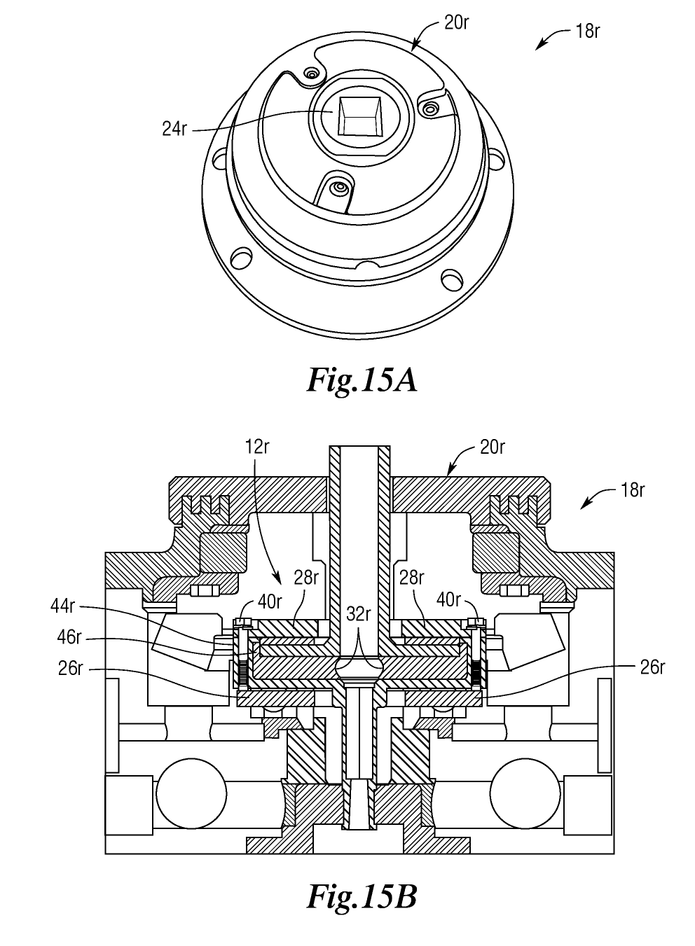

While all of the embodiments discussed so far have been described as additions that mount onto the chuck of a drill. It will be appreciated that any of the embodiments described above can be incorporated directly into the chuck of the drill. FIGS. 15A and 15B show one embodiment of drill 18r that incorporates a variation of the chuck isolator 12r shown in FIG. 3A directly into the chuck 20r of a drill 18r. Any of the other embodiments of chuck isolator shown and described herein and their variations can similarly be incorporated into drills.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A chuck isolator for a chuck of a drill comprising:
a base plate mountable to the chuck;
a drive plate connectable to a drill bit;
a first elastomeric member interposed between said base plate and said drive plate;
said base plate and said drive plate are each wider than the drill bit;
said chuck isolator is connectable to the chuck of the drill and capable of providing sound and vibration isolation when said chuck isolator is connected to the drill.

2. The chuck isolator of claim 1 further comprising said first elastomeric member is bonded to said drive plate.

3. The chuck isolator of claim 1 further comprising said first elastomeric member is bonded to said base plate.

4. The chuck isolator of claim 1 further comprising a top plate located above said drive plate.

5. The chuck isolator of claim 1 further comprising said first elastomeric member is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

6. The chuck isolator of claim 1 further comprising:
a top plate located above said drive plate; and
a second elastomeric member interposed between said top plate and said drive plate.

7. The chuck isolator of claim 1 further comprising:
a top plate located above said drive plate; and
a second elastomeric member interposed between said top plate and said drive plate and bonded to said drive plate.

8. The chuck isolator of claim 1 further comprising:
a top plate located above said drive plate; and
a second elastomeric member interposed between said top plate and said drive plate and bonded to said top plate.

9. The chuck isolator of claim 1 further comprising a sidewall that encloses said first elastomeric member within said chuck isolator.

10. The chuck isolator of claim 1 further comprising an opposing notch and flange incorporated into said drive plate and said base plate to limit the rotational movement of said first elastomeric member.

11. The chuck isolator of claim 1 further comprising an elastomeric outer ring.

12. The chuck isolator of claim 1 further comprising:
an elastomeric outer ring;
an intermediate plate;
said elastomeric outer ring interposed between said intermediate plate and said drive plate and bonded to said drive plate and said intermediate plate; and
said drive plate having a conical shape directed towards the chuck.

13. The chuck isolator of claim 1 further comprising:
an elastomeric outer ring;
said drive plate having a double conical shape directed towards both the chuck and the drill bit.

14. The chuck isolator of claim 1 further comprising a plurality of first elastomeric members each comprising an elastomeric core arranged between said base plate and said drive plate

15. The chuck isolator of claim 1 further comprising said drive plate and said base plate are cut and fit into corresponding opposing shapes that limit the rotational, movement of said first elastomeric member.

16. The chuck isolator of claim 1 further comprising a lip over the edge of said drive plate to limit the vertical and cocking movement of said drive plate.

17. A chuck of a drill comprising:
a chuck isolator incorporated within said chuck, said chuck isolator capable of providing sound and vibration isolation when the drill is in operation, said chuck isolator comprising:
a base plate mountable to the chuck;
a drive plate connectable to a drill bit;
a first elastomeric member interposed between said base plate and said drive plate; and
said base plate and said drive plate are each wider than the drill bit.

18. The chuck of claim 17 further comprising said first elastomeric member is bonded to said drive plate.

19. The chuck of claim 17 further comprising said first elastomeric member is bonded to said base plate.

20. The chuck of claim 17 further comprising a top plate located above said drive plate.

21. The chuck of claim 17 further comprising said first elastomeric member is polyisoprene, a polyisoprene blend, butyl rubber, acryl rubber, polyurethane, flurorubber, polysulfide rubber, ethylene-propylene rubber (EPR and EPDM), Hypalon, chlorinated polyethylene, ethylene-vinyl acetate rubber, epichlorohydrin rubber, chloroprene rubber, silicone, or another heavily damped elastomer.

22. The chuck of claim 17 further comprising:
a top plate located above said drive plate; and
a second elastomeric member interposed between said top plate and said drive plate.

23. The chuck of claim 17 further comprising:
a top plate located above said drive plate; and
a second elastomeric member interposed between said top plate and said drive plate and bonded to said drive plate.

24. The chuck of claim 17 further comprising:
a top plate located above said drive plate; and
a second elastomeric member interposed between said top plate and said drive plate and bonded to said top plate.

25. The chuck of claim 17 further comprising a sidewall that encloses said first elastomeric member within said chuck isolator.

26. The chuck of claim 17 further comprising an opposing notch and flange incorporated into said drive plate and said base plate to limit the rotational movement of said first elastomeric member.

27. The chuck of claim 17 further comprising an elastomeric outer ring.

28. The chuck of claim 17 further comprising:
an elastomeric outer ring;
an intermediate plate;
said elastomeric outer ring interposed between said intermediate plate and said drive plate and bonded to said drive plate and said intermediate plate; and
said drive plate having a conical shape directed towards the chuck.

29. The chuck of claim 17 further comprising:
an elastomeric outer ring;
said drive plate having a double conical shape directed towards both the chuck and the drill bit.

30. The chuck of claim 17 further comprising a plurality of first elastomeric members each comprising an elastomeric core arranged between said base plate and said drive plate.

31. The chuck of claim 17 further comprising said drive plate and said base plate are cut and fit into corresponding opposing shapes that limit the rotational movement of said first elastomeric member.

32. The chuck of claim 17 further comprising a lip over the edge of said drive plate to limit the vertical and cocking movement of said drive plate.

33. A drill assembly removably attached to the chuck of a drill, said drill assembly comprising:
a drill bit;
a chuck isolator;
a drill rod removably connected between said chuck isolator and said drill bit;
said chuck isolator comprising:
a base plate mountable to the chuck;
a drive plate connectable to said drill rod;
a first elastomeric member interposed between said base plate and said drive plate; and
said base plate and said drive plate are each wider than said drill bit;
said chuck isolator is connectable to the chuck and capable of providing sound and vibration isolation when the drill is in operation.
